(19) United States
(12) Patent Application Publication
(10) Pub. No.: US 2008/0290192 A1
(43) Pub. Date: Nov. 27, 2008

(54) Sprayer

(76) Inventor: Chin-Ming Ting, Shen Kang Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/752,352

(22) Filed: May 23, 2007

(51) Int. Cl. B05B 7/30

(52) U.S. Cl. 239/345

(57) ABSTRACT

A sprayer includes a spraying body, a paint cup and an adaptor that interconnects the spraying body and the paint cup for fluid communication between the spraying body and the paint cup. The spraying body includes a hand grip, a nozzle, and a connecting region communicating with the nozzle. The adaptor includes a connecting member, a positioning device and a cap mounted to an end of the connecting region. The cap includes a slot defined thereof for receiving the connecting member. The connecting member is pivotable within the slot and can be fixed at a specific angle by the positioning device. The cap also includes a bore defined thereof for receiving the positioning device. The paint cup is adapted to mount on the connecting member. The paint cup can change its orientation through the adjustable adaptor.

### BACKGROUND OF THE INVENTION

1. Field of the Invention

The present invention relates to a sprayer, in particular, to a sprayer that enables a paint cup connected thereto to change its orientation.

2. Description of the Related Art

Referring to FIG. 13, a conventional sprayer includes a spraying body 91 and a fluid-delivery cup 92. The fluid-delivery cup 92 is adapted to feed the fluid to the sprayer. Unfortunately, it can be difficult for an operator to use the sprayer to spray the fluid on a higher wall, or a lower wall, or a ceiling or a floor, as the fluid cannot flow into the sprayer via gravity easily anymore.

The present invention is, therefore, intended to obviate or at least alleviate the problems encountered in the prior art.

### SUMMARY OF THE INVENTION

A sprayer includes a spraying body, a paint cup and an adaptor that interconnects the spraying body and the paint cup for fluid communication between the spraying body and the paint cup. The spraying body includes a hand grip, a nozzle, and a connecting region communicating with the nozzle. The adaptor includes a connecting member, a positioning device and a cap mounted to an end of the connecting region. The cap includes a slot defined thereof for receiving the connecting member. The connecting member is pivotable within the slot and can be fixed at a specific angle by the positioning device. The cap also includes a bore defined thereof for receiving the positioning device. The paint cup is adapted to mount on the connecting member. The paint cup can change its orientation through the adjustable adaptor.

It is an objective of the present invention to provide the adjustment of the paint cup

It is another objective of the present invention to provide the operator to fast adjust the orientation of the paint cup through the use of the positioning device

Other objectives, advantages, and novel features of the invention will become more apparent from the following detailed description when taken in conjunction with the accompanying drawings.

### BRIEF DESCRIPTION OF THE DRAWINGS

For the present disclosure to be easily understood and readily practiced, the present disclosure will now be described for the purpose of illustration not limitation, in conjunction with the following figures, wherein;

FIG. 1 is a perspective view of a sprayer in accordance with the present invention.

FIG. 2 is an exploded perspective view of FIG. 1.

FIG. 3 is a side view, partly in section, of the sprayer in accordance with the present invention.

FIG. 4 is a partial, enlarged view of FIG. 3.

FIG. 5 is a cross-sectional view taken along line 5-5 in FIG. 4.

FIG. 6 is a partial, cross-sectional view similar to FIG. 5, illustrating the adjusting of the sprayer.

FIG. 7 is another side view, partly in section, of the sprayer according to the present invention.

FIG. 8 is another side view, partly in section, of the sprayer according to the present invention.

FIG. 9 is a partial, cross-sectional view of a sprayer in accordance with the second embodiment of the present invention.

FIG. 10 is a perspective view of a sprayer in accordance with the third embodiment of the present invention.

FIG. 11 is an exploded perspective view of FIG. 10.

FIG. 12 is a partial, cross-sectional view illustrating the adjusting of the sprayer in accordance with the third embodiment of the present invention.

FIG. 13 is a perspective view of a conventional sprayer.

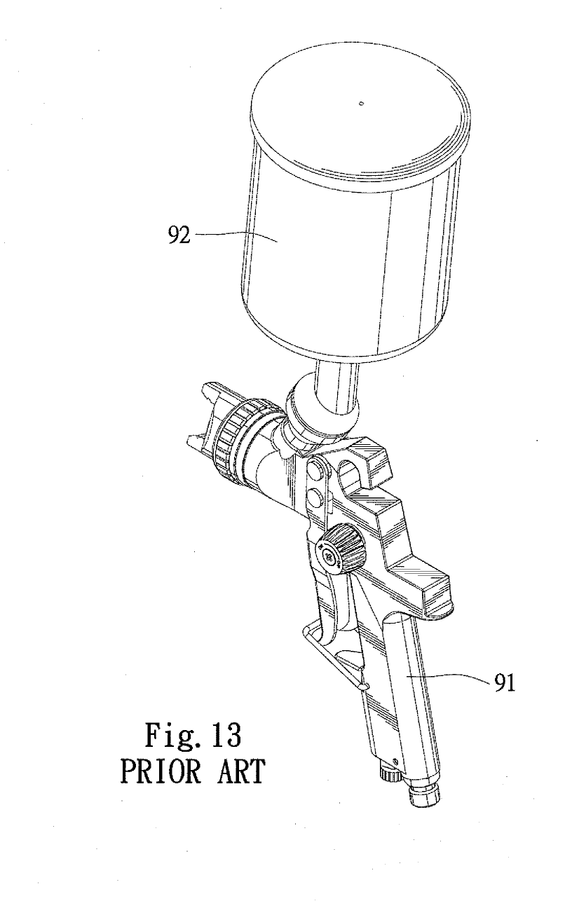

### DETAILED DESCRIPTION OF THE PREFERRED EMBODIMENT

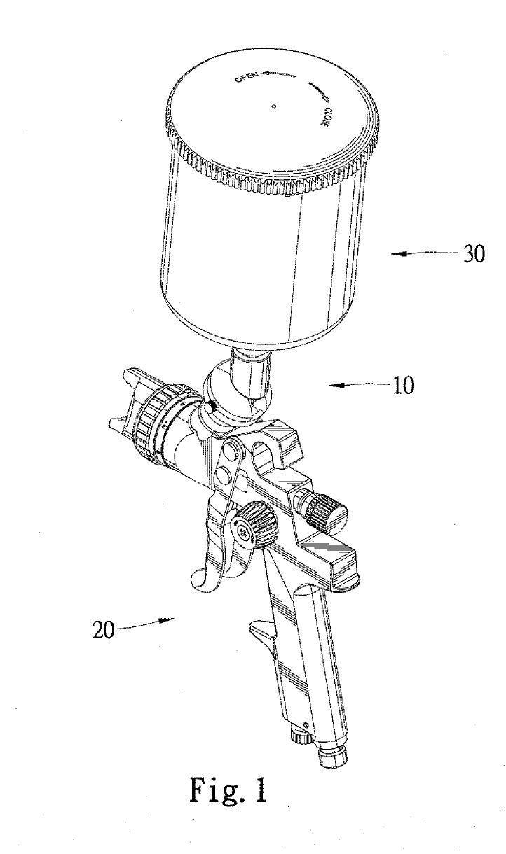

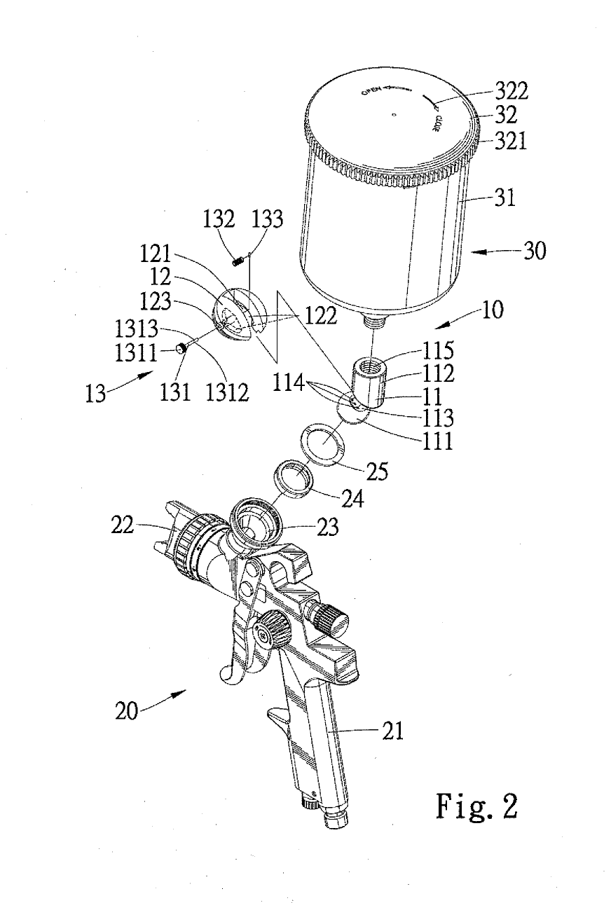

Referring to FIGS. 1 through 4, a sprayer in accordance with the present invention includes a spraying body 20, a paint cup 30 and an adaptor 10 that interconnects the spraying body 20 and the paint cup 30 for fluid communication between the spraying body 20 and the paint cup 30.

The spraying body 20 includes a hand grip 21, a nozzle 22 and a connecting region 23 communicating with the nozzle 22. The spraying body 20 also includes a seal 24 and a spacer 25 disposed within the connecting region 23.

The adaptor 10 includes a connecting member 11, a cap 12 and a positioning device 13. The connecting member 11 has a first end 111, a second end 112 and a neck 113 interconnecting the first end 111 and the second end 112. In the preferred embodiment of the present invention, the first end 111 is formed of a spherical body 20, and the second end 112 is formed of a cylindrical body 112. The connecting member 11 also includes a passage 115 defined therein. The passage 115 extends through the first end 111, the neck 113 and the second end 112. The neck 113 includes a plurality of indentations 114 defined thereof.

The cap 12 is mounted to an end of the connecting region 23. The cap 12 has a slot 121 and two cavities 122 defined thereof. The slot 121 has a closed end and an open end. The slot 121 is disposed between the cavities 122. The slot 121 is adapted to receive the neck 113 of the adaptor 10. The neck 113 is moveable within the slot 121. The cavities 122 are adapted to partially receive the first end 111 of the connecting member 11. The cap 12 also includes a bore 123. The bore 123 communicates with one of the cavities 122 and is disposed at a side thereof for receiving a positioning device 13.

The positioning device 13 includes a body 131, an elastic element 132 and a pin 133. The body 131 has a head 1311 and a pole 1312 disposed at opposing ends. The pole 1312 includes an aperture 1313 defined thereof for receiving the pin 133. The pole 1312 is adapted to receive the elastic member 132 and the pin 133. The pin 133 prevents the elastic member 132 from detaching from the pole 1312. The head 1311 is disposed outside the bore 123 while the pole 1312, the elastic member 1312 and the pin 133 are disposed in the cavity 122.

The paint cup 30 includes a fluid-receiving body 31 and a cover 32. The paint cup 30 is adapted to threadly connect to the engaging end 112 of the adaptor 11. The fluid-receiving body 31 is preferably a funnel-shaped chamber. The cover includes a plurality of anti-slip sections 321 about the perimeter thereof. The cover 32 also includes a mark 322 for indicating the user which direction is to open the cover 32 and which direction is to close the cover 32

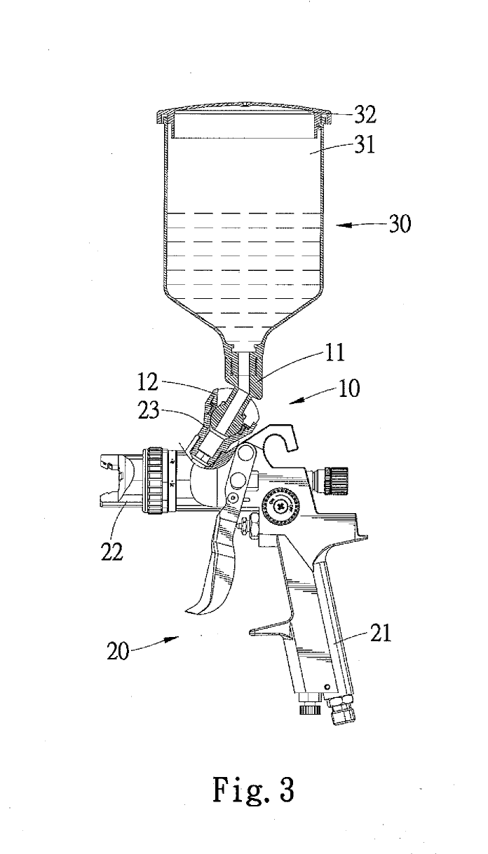

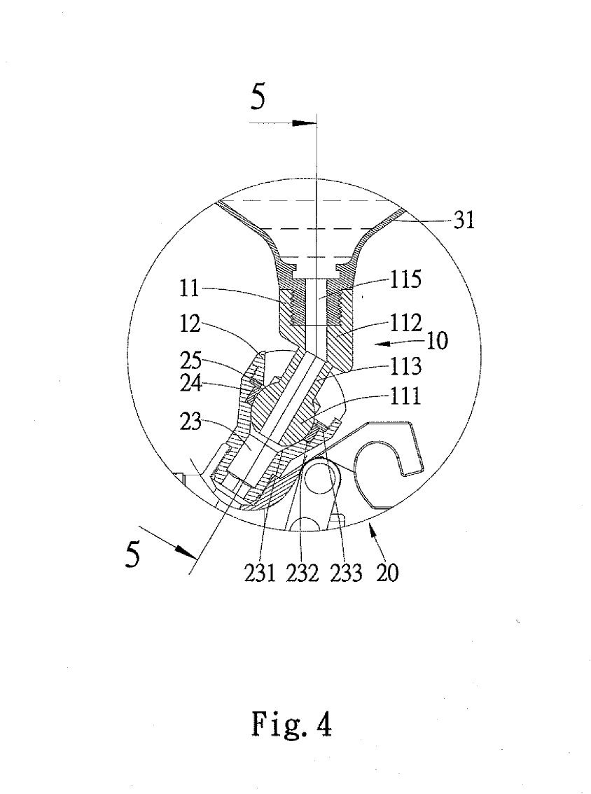

Referring to FIGS. 3 and 4, the connecting region 23 includes a tapered section 231 pivotally receiving the first end 111 of the connecting member 11. The connecting region 23 also includes a first groove 232 and a second groove 233 for reception of the seal 24 and the spacer 25 respectively. The cap 12 confines the first end 111 within the connecting region 23.

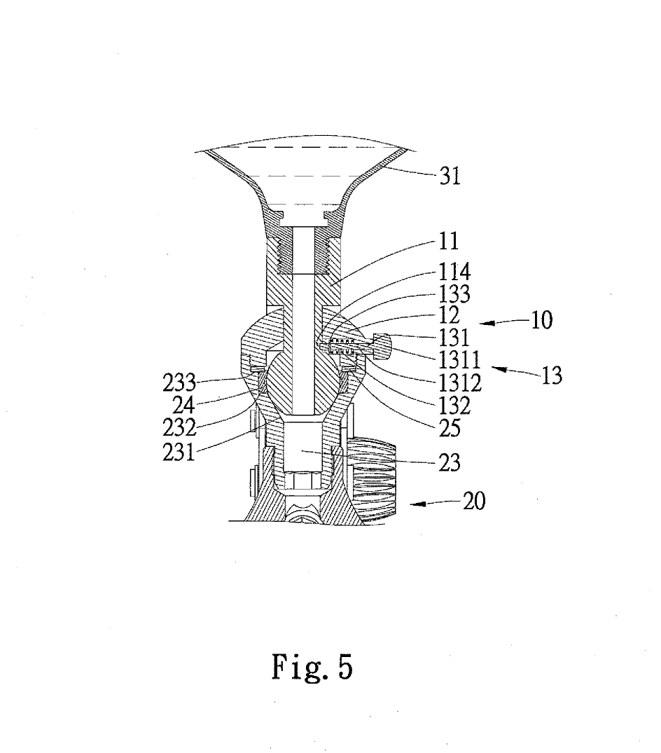

Referring to FIG. 5, the positioning device 13 engages with the neck 113 by inserting the end of the pole 1312 of the positioning device 13 in the indentation 114. Accordingly, the paint cup 13 is not capable of changing its position.

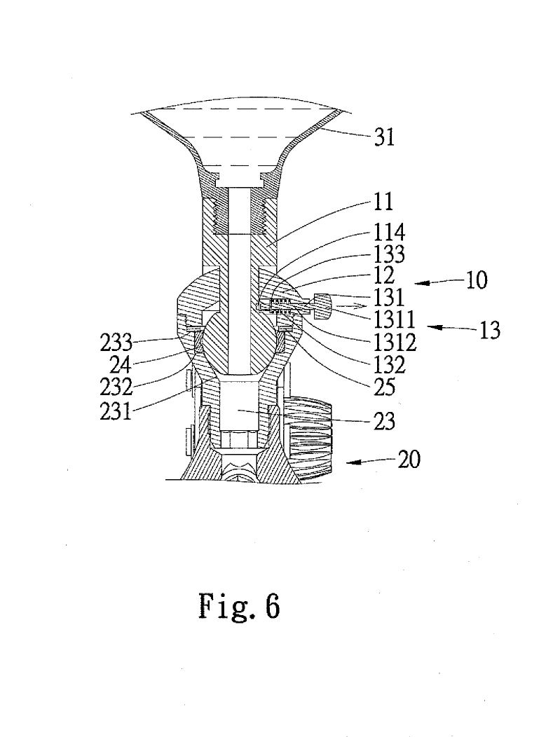

Referring to FIG. 6, the positioning device 13 is withdrawn in an arrow-indicated direction; the pole 1312 of the positioning device 13 disengages from the indentation 114 of the neck 113 and thereby allowing the paint cup 13 to change its position. Thereafter, the operator releases the head 1311 of the positioning device 13, the pole 143 of the positioning device 13 is biased by the elastic element 132 to engages with another indentation 114 of the neck 113.

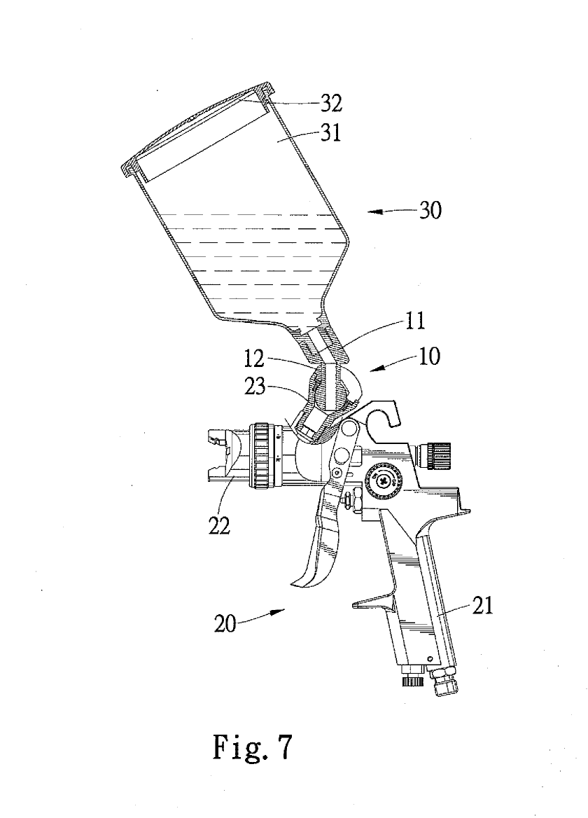

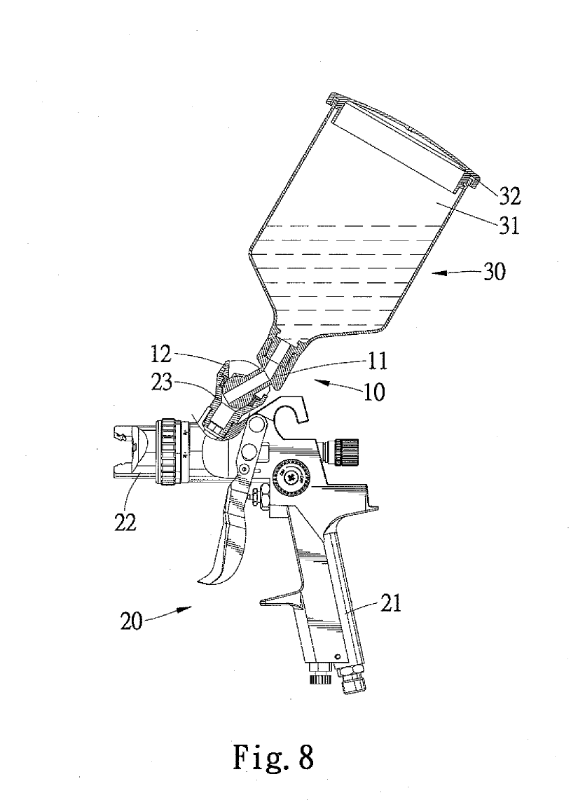

Referring to FIGS. 7 and 8, the paint cup 30 is tilted forward in order to spray the fluid on a higher wall or a ceiling. The paint cup 30 is tilted backward in order to spray the fluid on a higher wall or a ceiling.

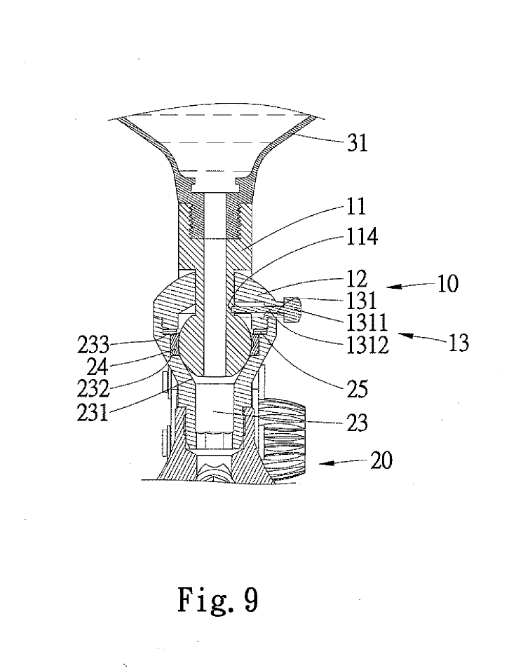

FIG. 9 shows a second exemplary embodiment in accordance with the present invention. The second embodiment differentiates from the first, as the elastic element 132 and the pin 133 are omitted from the positioning device 13. Furthermore, the pole 1312 of the positioning device includes a threaded section so as to threadly engage with the indentation 114.

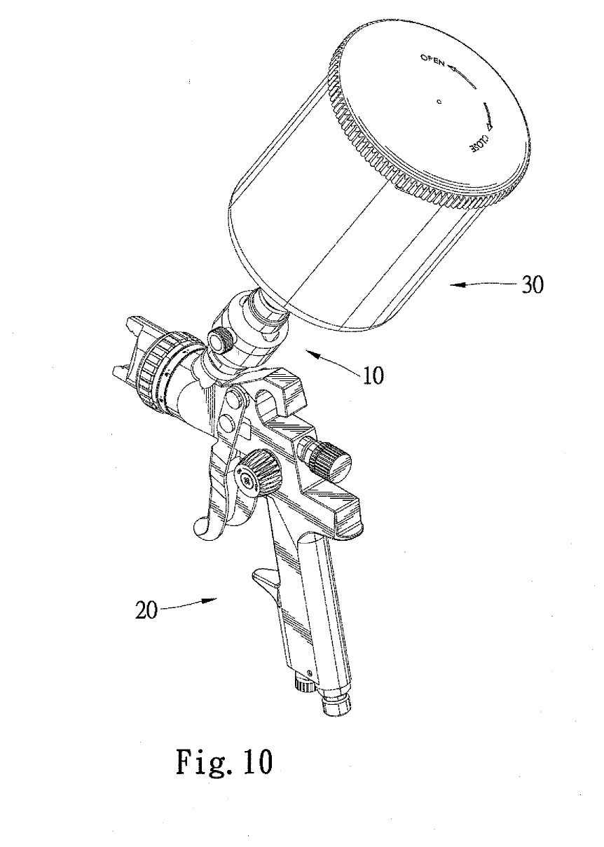

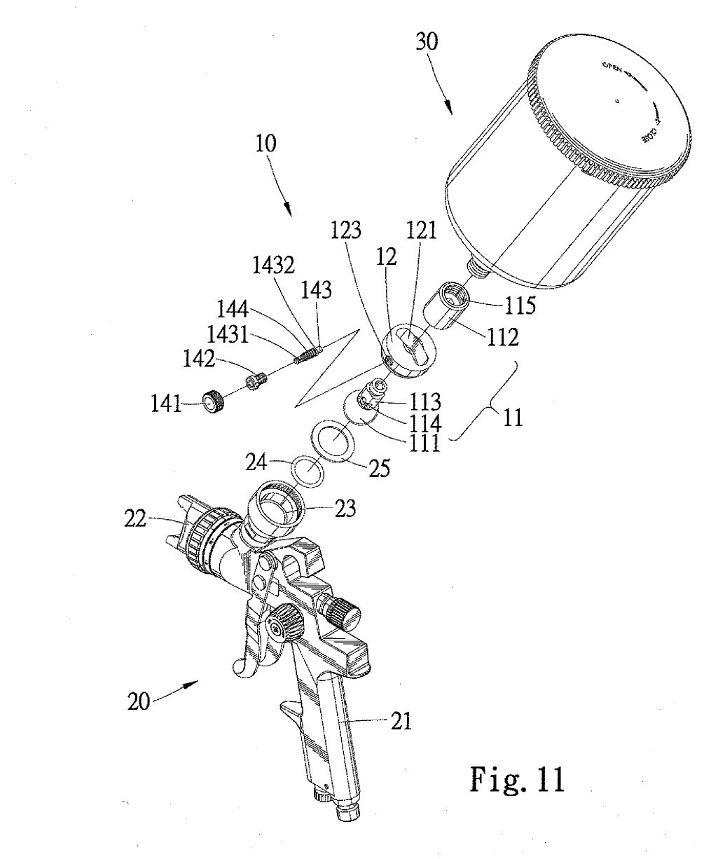

FIGS. 10 and 11 show a third exemplary embodiment in accordance with the present invention. The third embodiment differentiates from the first, as the connecting member 11 is formed of two pieces. The first piece includes a first end 111 and the neck 113. The second piece includes a second end 112. Furthermore, the slot 121 defined in the cap 12 is enclosed. The neck 113 is inserted through the slot 121 and threadly connected to the second end 112. The positioning device 14 is also different. The positioning device 14 includes a knob 141, a joining member 142, an engaging member 143 and an elastic element 144. The engaging member 143 is formed with a threaded region 1431 and a flange 1432. The threaded region 1431 is adapted for reception of the elastic member 144. The flange 1432 is adapted to prevent the elastic member 144 from detaching from the engaging member 143.

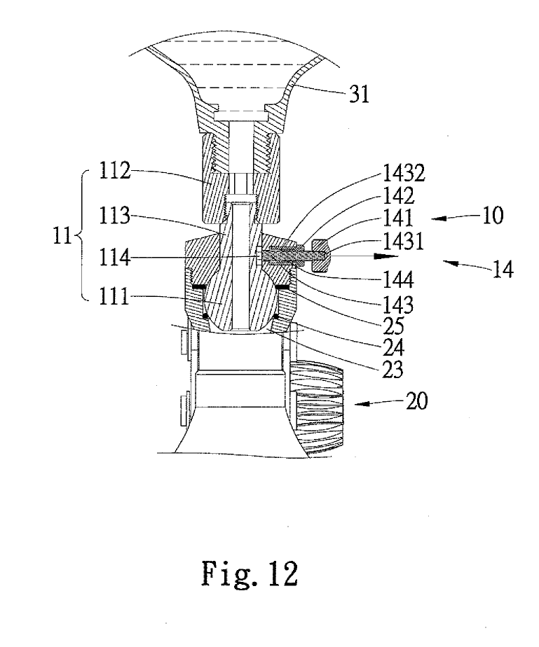

Referring to FIG. 12, the positioning device 14 is withdrawn in an arrow-indicated direction, the engaging member 143 disengages from the indentation 114 of the neck 113 and thereby allowing the paint cup 13 to change its position. Thereafter, the operator release the knob 141, the engaging member 143 of the positioning device 14 is biased by the elastic element 144 to engage with another indentation 114 of the neck 113.

In one aspect of the sprayer embodying the present invention, the paint cup 30 can change its orientation by withdrawing the position device 13 from the neck 113.

In another aspect of the sprayer embodying the present invention, the first end 11 of the adapter 10 is pivotable. Thus the paint cup 30 connected to the adapter 10 is tiltable.

In yet another aspect of the sprayer embodying the present invention, the position device 13 can be threadly engaged with the indentation 114 of the adapter 10 or elastically biased to engage with indentation 114 of the adapter 10.

In still another aspect of the sprayer embodying the present invention, the paint cup 30 can be quickly changed to a different orientation via the positioning device 13.

While the specific embodiments have been illustrated and described, numerous modifications come to mind without significantly departing from the spirit of invention and the scope of invention is only limited by the scope of accompanying claims.

What is claimed is:

1. A sprayer comprising:
a spraying body including a hand grip, a nozzle and a connecting region communicating with said nozzle;
an adapter including a connecting member, a positioning device and a cap mounted to an end of the connecting region, with the cap including a slot, with the slot receiving the connecting member, with the connecting member being pivotable within the slot and can be fixed at a specific angle by the positioning device, and with the cap including a bore receiving the positioning device and;
a paint cup mounted to the connecting member for fluid communication with the adapter.

2. The sprayer as claimed in claim 1 wherein the connecting member includes a first end, a second end and a neck, with the neck interconnecting the first end and the second end, and with the neck being pivotable within the slot.

3. The sprayer as claimed in claim 2 wherein the first end, the second end and the neck are integrally formed.

4. The sprayer as claimed in claim 2 wherein the first end is threadly connected to the second end.

5. The sprayer as claimed in claim 2 wherein the neck includes a plurality of indentations defined thereof for receiving the positioning device.

6. The sprayer as claimed in claim 2 wherein the slot has a closed end and an open end.

7. The sprayer as claimed in claim 2 wherein the cap includes two cavities disposed oppositely and separated by the slot.

8. The sprayer as claimed in claim 7 wherein the bore communicates with one of the cavities.

9. The sprayer as claimed in claim 2 wherein the first end is formed of a spherical body.

10. The sprayer as claimed in claim 1 wherein the connecting region includes a seal disposed therein.

11. The sprayer as claimed in claim 10 wherein the seal is elastomeric.

12. The sprayer as claimed in claim 10 wherein the connecting region includes a first groove for receiving the seal.

13. The sprayer as claimed in claim 1 wherein the connecting region includes a spacer disposed therein.

14. The sprayer as claimed in claim 13 wherein the connecting region includes a second groove for receiving the spacer.

15. The sprayer as claimed in claim 1 wherein the connecting region includes a tapered section that pivotably receives the connecting member.

16. The sprayer as claimed in claim 1 wherein the positioning device includes a threaded section, the bore is threadly engaged with the bore.

17. The sprayer as claimed in claim 1 wherein the positioning device includes a body receiving an elastic element and a pin, wherein the pin prevents the elastic element from detaching from the body.

18. The sprayer as claimed in claim 17 wherein the body includes a head and a pole disposed at opposing ends, with the pole including an aperture being adapted to receive the pin, and with the head being disposed outside the cap.

19. The sprayer as claimed in claim 1 wherein the positioning device is comprised of a knob, a joining member, an engaging member and an elastic element.

20. The sprayer as claimed in claim 19 wherein engaging member is formed with a threaded region and a flange, with the threaded region being adapted for reception of the elastic member, and with the flange being adapted to prevent the elastic member from detaching from the engaging member.
